(19) United States
(12) Patent Application Publication
(10) Pub. No.: US 2026/0326347 A1
(43) Pub. Date: Oct. 22, 2026

(54) FABRICATION OF TIRE TREAD USING LITHOGRAPHY BASED METHODS

(71) Applicant: BRIDGESTONE BANDAG, LLC, Nashville, TN (US)

(72) Inventors: Terry A. Westaway, Muscatine, IA (US); John W. Whitley, Muscatine, IA (US)

(73) Assignee: BRIDGESTONE BANDAG, LLC, Nashville, TN (US)

(21) Appl. No.: 19/109,828

(22) PCT Filed: Aug. 14, 2023
(86) PCT No.: PCT/US2023/072146

§ 371 Date: Mar. 7, 2025

Related U.S. Application Data
(60) Provisional application No. 63/405,027, filed on Sep. 9, 2022.

(51) Int. Cl. B29C 35/08; B33Y 80/00; B60C 11/02; B60C 11/12

(52) U.S. Cl. CPC B29C 35/0805; B60C 11/02; B60C 11/12; B29C 2035/0822; B33Y 80/00

(57) ABSTRACT

A method of treading a tire is provided. The method includes providing a tire casing and further includes providing a material for forming a tread element on the tire casing. The material is polymerizable. A first layer of the material is applied to the tire casing. A curing source is directed to at least a portion of the first layer. The curing source is configured to cure the material on the tire casing. At least a portion of the first layer on the tire casing is at least partially cured such that at least a portion of the first layer couples to a surface of the tire casing to form the tread element. Uncured material from the tire casing is removed by a removal process.

### FIELD

The present disclosure relates generally to the field of manufacturing tires. Specifically, the present disclosure relates to the fabrication of tread elements for tires.

### BACKGROUND

Additive manufacturing systems are typically configured to add or deposit material in a layer-by-layer process to fabricate structures.

### SUMMARY

One embodiment of the present disclosure relates to a method of treading a tire. The method includes providing a tire casing; providing a polymerizable material which is able to form a tread element on the tire casing; applying a first layer of the material to the tire casing; and directing a curing source to at least a portion of the first layer. The curing source is configured to cure the material on the tire casing. The method further includes removing, by a removal process, uncured material from the tire casing to thereby form the tire.

Another embodiment of the present disclosure relates to a method of forming a tread element. The method includes applying a first layer of an uncured material to a surface of a substrate, directing a curing source to the first layer of uncured material, and curing the first layer of uncured material, forming a first layer of cured material on the substrate. The method further includes sequentially forming a plurality of layers of cured material on the first layer of cured material. Each layer of the plurality of layers formed by applying a layer of uncured material on an immediately preceding layer of cured material and directing the curing source to a first groove position on the tread element and a second groove position on the tread element. The first groove position and the second groove position are separated by a distance defining a groove. The layer of uncured material is cured at the first groove position and the second groove position to form the groove.

Another embodiment of the present disclosure relates to a method of treading a tire. The method includes mounting a tire casing within a rotation machine, applying a first layer of a material to the tire casing and directing a curing source to at least a portion of the first layer of material as the tire casing is rotated, forming a cured first layer. The method further includes applying a second layer of material over the cured first layer and directing the curing source to at least a portion of the second layer as the tire casing is rotated, forming a cured second layer.

### BRIEF DESCRIPTION OF THE DRAWINGS

FIG. 1 is a front, cross-sectional view of a tire casing, according to an example embodiment,

FIG. 2 is a block diagram of a method of forming a tire, according to an example embodiment,

FIG. 3 is a front, cross-sectional view of a tire, according to an example embodiment, and

FIG. 4 is a perspective view of the tread element of FIG. 3.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of fabricating tire tread. The various concepts introduced above and discussed in greater detail below may be implemented in any number of ways, as the described concepts are not limited to any particular manner of implementation. Examples of specific implementations and applications are provided for illustrative purposes and are not intended to be limiting.

### I. Overview

Tires are used in various applications and under a variety of circumstances. Some tires may be designed to withstand the forces of a landing aircraft. Some tires may be designed to provide specific performance effects on surfaces covered in snow and ice. Some tires may be manufactured to be more suited to be repairable and retreaded.

Tires are used in applications ranging from aircraft landing gear to long-haul tractor-trailers to performance vehicles and, generally, any vehicle. As a result, tread elements should be fabricated in a cost effective and efficient matter. Current methods include dispensing unvulcanized rubber into a mold and vulcanizing the rubber to form the tread element. These methods may require a plurality of molds for different tread designs.

Fabrication of tread elements using additive manufacturing according to the techniques of the present disclosure provide various benefits. For example, additive manufacturing methods facilitate the formation of a tread element without a mold. Further, in some cases, the vulcanization process may be eliminated or reduced as the additive manufacturing method of the present techniques utilizes material to form the tread element at specific locations on the tire casing and may utilize feedstock that do not require vulcanization (e.g., thermoplastic filament) or that may be cured under a variety of conditions, such as cure temperatures significantly lower than the cure temperatures required to press tread. For example, additive manufacturing methods may extrude material onto a substrate and then direct one or more curing sources to the material to thereby cure the material. As another example, additive manufacturing methods may deposit molten thermoplastic polymeric material at specific locations on a substrate that will solidify on cooling. Additive manufacturing methods may also include causing material to change phases from fluid material to a solid material directly on a substrate using one or more energy sources. Further, the fabrication of tread elements using additive manufacturing allows the tread element to possess various material characteristics throughout the entirety of the tread element, e.g., by utilizing various materials to form the tread element. Moreover, additive manufacturing may also allow various and complex tread element designs to be made, which are difficult or impossible to achieve through typical methods.

### II. Terms

As used herein, the term “cured” refers to a material that has been polymerized to achieve a crosslink density suitable for a specific application. Conversely, “uncured” refers to materials that are in their raw form and have not been cured.

As used herein, the term “precured tire tread” refers to a tire tread or build-up (e.g., precured product having no tread pattern thereon; blank; slick) that is separate from (e.g., not cured to) a tire casing. After a precured tire tread has been cured to a tire casing, the precured tire tread becomes a tire tread, and the combination of the precured tread cured to the tire casing forms a tire. The precured tire tread may take the form of a strip, oval, circle, ring, or other shapes.

As used herein, the term “tread element” may refer to a precured tire tread. The precured tire tread may include materials and features such as, but not limited to, studs, reinforcing fabrics, Kevlar, nylon, cords, or other features and materials.

### III. Overview of Methods for Fabricating Tire Treads Using Lithography Based Methods

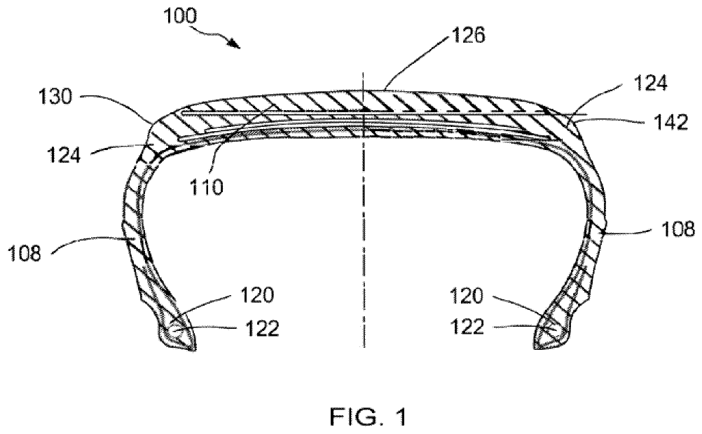

Referring to FIG. 1, a front, cross-sectional view of a tire casing (e.g., new tire casing, tire carcass, etc.) 100 is shown, according to an example embodiment. The tire casing includes a tread element mounting surface 126 (e.g., mounting surface, mating surface, bonding surface, curing surface, etc.) on the tire casing 100. The mounting surface 126 extends circumferentially about the tire casing 100 and extends axially across the outer wall 110 until it terminates proximate to the shoulder areas 124. The mounting surface 126 exhibits a curvature between the shoulder areas 124. In some embodiments, the mounting surface 126 may be processed (e.g., by buffing) to achieve a shape having a rounded (e.g., toroidal) radius extending between the shoulder areas 124. The tire casing 100 may be a radial tire or a bias ply tire, for example.

The tire casing 100 includes a pair of sidewalls 108 bounded by a generally radial outer wall 110 (e.g., crown, etc.) that extends between the sidewalls 108. Each of the sidewalls 108 extends radially inward from the outer wall 110 and terminates at a bead area 120 structured for mounting on a tire rim. The bead area 120 may be designed in a variety of configurations depending on, for example, tire type, tire size, or rim configuration. The bead area 120 includes a bead 122 that has metal strands or wires which may increase the strength of the bead area 120.

The sidewalls 108 may include multiple layers, such as a rubber layer, a radial ply, and an inner liner, which cooperate to provide strong and flexible sidewalls 108. The sidewalls 108 are joined to the outer wall 110 and the tire tread 106 through a pair of shoulder areas 124. The shoulder areas 124 are contiguous with the sidewalls 108 and the outer wall 110. In some embodiments, the shoulder areas 124 are contiguous with the tire tread 106.

In some embodiments, the tire casing 100 is a new tire casing without a use history. The mounting surface 126 of the new tire casing is configured to receive a tread element.

In other embodiments, the tire casing may be from a tire with a use history. The use history may be such that the tread has been reduced in one or more locations so as to necessitate retreading. For example, after the tire tread of a tire is reduced beyond a certain limit, the tire may be discarded, re-grooved, or retreaded. In cold process retreading, what remains of the tire tread is removed from the tire casing 100 by a buffing machine through a buffing (e.g., removal) operation. During the buffing operation, the tire tread is ground away from the tire casing 100, leaving the tread mounting surface 126. During the buffing operation, a portion of the tire tread may be left behind on the tire casing 100, e.g., if it is desired to increase a thickness of the outer wall 110 before applying a tread element, as described herein, to the tire casing 100. Removal of the tire tread leaves behind (e.g., exposes, reveals, etc.) the mounting surface 126. After the tire tread is removed and the mounting surface 126 is exposed, skiving and filling may be performed on the tire casing 100. Skiving and filling includes the removal of and filling of features (e.g., partially missing material, undesired material, scuffs, scratches, holes, nicks, punctures, tears, etc.) present in the tire casing 100 prior to making a repair or performing a retread operation. Often, the tire casing 100 accumulates features due to bits or other sharp objects the tire contacts with during use. The features are first ground smooth by an appropriate cutting tool (e.g., sidewall buffer, wire brush, etc.) and then filled with repair gum (e.g., uncured rubber material, etc.). The affected areas may be filled to the level of the mounting surface 126 (e.g., such that the mounting surface 126 remains smooth) to avoid air pockets between the mounting surface 126 and the later applied tread element. After the buffing, skiving and filling operations for a new tire casing or a tire with a use history, a tread element (e.g., precured tire tread, etc.) is coupled to the tire casing 100.

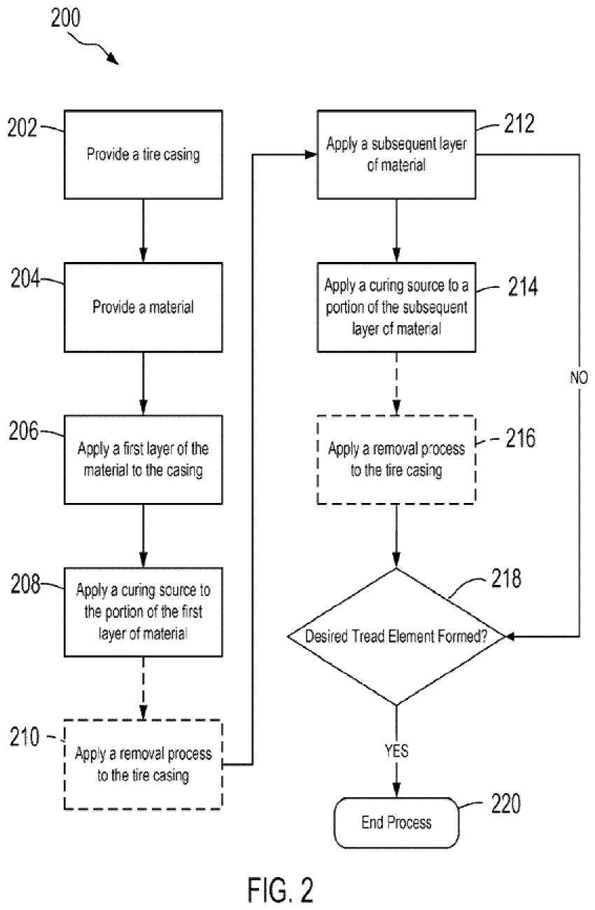

Referring to FIG. 2, a block diagram of a method 200 of forming a tire is shown. In step 202, a substrate is provided. The substrate may be a planar element such as a flat plate or a flat panel or may be a curved plate or a curved panel. In some embodiments, the substrate may be a tire casing (e.g., tire casing 100). The tire casing may be unbuffed such that the tire casing is a new tire casing with a new mounting surface or a tire casing having tire tread with a use history. In some embodiments, the tire casing may be buffed such that the surface of the tire casing is removed of portions having reduced tread and/or features. In other embodiments, the tire casing may be provided such that there are no reduced tread portions or features. The tire casing may expose a mounting surface (e.g., mounting surface 126, etc.).

In step 204, a material (e.g., feedstock, etc.) for forming a tread element on a tire casing is provided. The material may be a fluid material. The material is a polymerizable material such that the material may change phases to become a solid material. In some embodiments, the material is liquid rubber, liquid polyurethane, or various monomers and/or (pre)polymers and compounding ingredients, such as carbon black, silica, anti-degradants, and zinc oxide or any combination thereof. In some embodiments, the material includes a reactive/polymerizable diluent. The reactive/polymerizable diluent may be a low molecular weight liquid monomer capable of polymerizing to form an elastomeric material. The reactive/polymerizable diluent may be a low molecular weight (meth)acrylate or epoxide.

In step 206, a first layer of the material is applied to the tire casing. The first layer of material may be applied with a roller or a sprayer. In some embodiments, the first layer of material is applied using a film depositing technique. For example, at least one roller may be used to apply the first layer of the material to the entire casing.

In step 208, a curing source is applied to the portion of the first layer of material. The curing source is configured to cure the first layer of material to the tire casing so as to begin the formation of the tread element on the tire casing. The curing source may include one or more visible light emitters, ultraviolet light emitters, arc lamps, infrared emitters, radio wave emitters, gamma ray emitters, microwaves, radiation emitters, etc., or any other energy source configured to cure the material. In operation, the curing source is directed to specific regions of the material applied on the tire casing such that the material cures and couples to the mounting surface of the tire casing (e.g., the material cures on the tire casing). In some embodiments, portions of the layer may be partially cured to facilitate bonding with subsequently applied layers of material.

In step 210, a removal process may be applied to the tire casing. In one embodiment, the removal process includes applying a solvent to the tire casing. The solvent is configured to remove unpolymerized material from the surface of the tire casing. In operation, the solvent is applied to the tire casing. In some embodiments, the solvent is sprayed on to the tire casing. In other embodiments, the solvent is applied to the tire casing by rotating the tire casing through a dip tank. The solvent dissolves (e.g., reacts, solvates, etc.) the unpolymerized material such that the unpolymerized material is washed off the tire casing. In some embodiments, the solvent dissolves with the unpolymerized material such that the unpolymerized material is soluble and dissolves within a tank of fluid (e.g., within a reservoir or other container in which the material is submerged). Consequently, the unpolymerized material may be recovered through a separation technique such that the unpolymerized material may be reused. In some embodiments, the material includes the reactive/polymerizable diluent that is a component of the polymerizable material, which can promote the ease of separating/recovering the unpolymerized material.

In another embodiment, the removal process may include using a device configured to remove unpolymerized material from the surface of the tire casing. The device may be a blower, a vacuum or an absorbent roller. In operation, the device is used to remove the unpolymerized material from the surface of the tire casing. The unpolymerized material may be collected into a receptacle such that the unpolymerized material may be reused. In some embodiments when the device is an absorbent roller, the absorbent roller comes in contact with the tread element formed on the tire casing to absorb the unpolymerized material. Then, the absorbent roller may be pressed to remove the unpolymerized material.

In yet another embodiment, the removal process includes using at least one energy source (e.g., heat source, radiation source, etc.). The energy source is configured to cause the unpolymerized material to evaporate from the tire casing. The evaporated unpolymerized material is captured and allowed to condense such that the unpolymerized material may be reused. In some embodiments, when the removal process includes using an energy source, the material may be volatile and does not undergo thermal polymerization.

In step 212, a subsequent layer of material is applied to the tire casing. In particular, the subsequent layer is applied to the casing over the cured first layer. In step 214, a curing source, as described herein, is applied to a portion of the subsequent layer of material. Consequently, the portion to which the curing source is directed (e.g., is applied to) cures. In this manner, the portion that is cured forms the subsequent layer and the portion to which the curing source is not directed remains uncured. In some embodiments, portions of the layer are partially cured to facilitate bonding to subsequently applied layers. In step 216, the removal process, as described herein, may be applied to the tire casing. The removal process removes the portion of the subsequent layer that remains uncured. In step 218, a determination is made as to whether the desired tread element is formed. For example, a determination is made as to whether a tread element that is formed is made having the desired thickness. If a determination is made that a desired tread element is not formed, steps 212 to 216 are repeated to form a plurality of layers of tread element such that a tire including a desired tread element is formed. If a determination is made that the desired tread element is formed, in step 220 the process ends. In some embodiments, the layer of material may be partially cured to facilitate bonding with subsequently applied layers.

Further, in some embodiments, grooves may be formed on the tread element by performing the process of steps 212 to 216. For example, the material is applied to the tire casing, as described herein. The curing source is applied to a first portion of the tread element and a second portion of the tread element such that the first portion and the second portion cure. Uncured material may be present between the first portion and the second portion. The removal process is applied to remove the uncured material present between the first portion and the second portion. This process may be repeated for subsequent layers such that a groove forms between the first portion and the second portion. In particular, the first portion and the second portion may be formed to be vertical walls by applying material and curing the material such that one or more vertical walls form on the tire casing.

In some embodiments, the tire casing is mounted within a rotation machine. The rotation machine may enclose the tire casing within a chamber. The chamber may include an inert atmosphere to reduce the effects of oxygen on radical polymerization. In other embodiments, the tire casing is mounted within a rotation machine which is not placed within a chamber containing an inert atmosphere. In such embodiments, where the rotation machine is not placed within this type of chamber, the curing source used may be a heat source or infrared source, or any other curing source that does not polymerize the material using radical polymerization. The tire casing is rotated as a layer of the material is applied to the tire casing. As the material is applied while the tire rotates, the curing source is directed toward specific regions on the surface of the layer of the material. The curing source facilitates curing portions of the first layer and each of the plurality of layers to the tire casing. Consequently, the material may have a higher viscosity or may exhibit shear thinning such that it is capable of being deposited on the tire and, as the tire rotates, it remains positioned on the tire casing where it was applied and does not run.

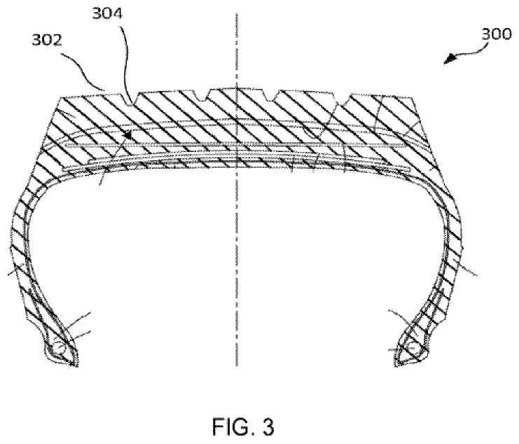

Referring now to FIG. 3, a front cross-section view of the retreaded tire 300 is shown. The retreaded tire incudes a tread element 302. The tread element 302 is formed using the methods described herein. The tread element 302 includes grooves 304. The grooves 304 are formed by curing a plurality of layers in a first position and a second position where a space exists between the first position and the second position. The space defines the groove 304 formed on the tread element 302. The plurality of grooves 304 may have a width approximately in a range between 0.095 in. and 1.05 in. (e.g., 0.095 in., 0.1 in., 0.2 in. 0.3 in., 0.4 in., 0.5 in., 0.6 in., 0.7 in., 0.8 in., 0.9 in., 1 in., 1.05 in. etc.). In some embodiments, a first groove 304 may have a first width and a second groove 304 of the plurality of grooves 304 may have a second width where the second width is different from the first width.

The tread element 302 formed may include a rolling resistance, as measured by 100 C tan(8), in a predetermined range of approximately 0.03 to approximately 0.3. In some embodiments, the tread element 302 is formed such that a portion of the tread element 302 has a first rolling resistance and another portion of the tread element 302 has a second rolling resistance, where the second rolling resistance is different from the first rolling resistance. The rolling resistance of the tread element 302 varies by controlling the exposure of the curing source to the materials. In general, the longer the curing source is applied to the material, the greater the crosslink density. Further, the greater the crosslink density of the material, the lower the rolling resistance generally is. Conversely, the lower the crosslink density, the greater the rolling resistance generally is. In some embodiments, the rolling resistance is further varied by additional factors and properties of the material such as filler loading, filler type, material type, etc.

Further, in some embodiments, the tread element 302 formed may include a tear resistance, as measured by tensile elongation at break, of approximately 200%-800% (e.g., 200%, 250%, 300%, 350%, 400%, 450%, 500%, 550%, 600%, 650%, 700%, 750%, 800%, etc.). In some embodiments, a portion of the tread element may have a first tear resistance and another portion of the tread element may have a second tear resistance, wherein the second tear resistance is different from the first tear resistance. The tear resistance of the tread element 302 varies by controlling the crosslink density of the material. Specifically, when the material has a lower crosslink density, the tear resistance is typically greater whereas when the material has a higher crosslinking density, the tear resistance is typically lower. In some embodiments, the tear resistance is further varied by additional factors or properties of the material, such as filler loading, filler surface area, filler type, material type, etc.

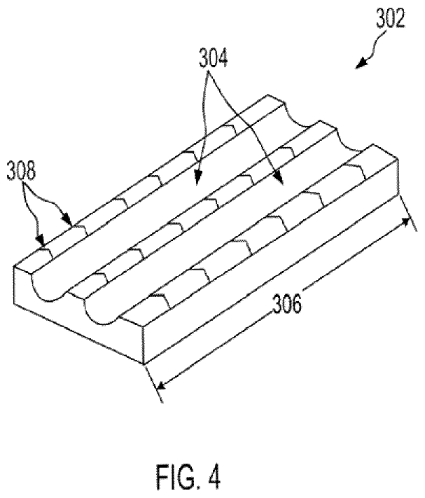

Referring to FIG. 4, a perspective view of the tread element 302 is depicted. The tread element 302 is fabricated using the methods disclosed herein. The tread element 302 includes a length 306. The length 306 of the tread element 302 may be approximately in a range of 3.8 feet (ft.) to 12.5 ft. (e.g., 3.8 ft., 4 ft., 4.5 ft. 5 ft., 5.5 ft., 6 ft., 6.5 ft., 7 ft., 7.5 ft., 8 ft., 8.5 ft., 9 ft., 9.5 ft., 10 ft., 10.5 ft., 11 ft., 11.5 ft., 12 ft., 12.5 ft., etc.). The tread element 302 also includes a plurality of sipes 308. The plurality of sipes 308 is formed through the method described herein. Specifically, a material is applied to the tire casing. The curing source is then applied to a first portion and a second portion, which are separated by a distance measured along the length of the tread element 302. In some embodiments, the distance is measured along the width of the tread element 302. The first portion and the second portion are separated by a distance such that the sipe may have a width approximately in a range between 0.95 millimeter (mm) and 10.5 mm (e.g., 0.95 mm, 1 mm, 2 mm, 3 mm, 4 mm, 5 mm, 6 mm, 7 mm, 8 mm, 9 mm, 10 mm, 10.5 mm, etc.). The removal process is applied to the casing to remove the uncured material between the first portion and the second portion such that the sipe is formed.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

References herein to the relative order of elements (e.g., “first”, “second,” “third,” “fourth”) are merely used for the purpose of illustration and are not intended to be limiting.

Although the figures may show a specific order of method steps, the order of the steps may differ from what is depicted. In some embodiments, two or more steps may be performed concurrently or with partial concurrence. All such variations are within the scope of the disclosure. While various aspects and embodiments have been disclosed herein, other aspects and embodiments will be apparent to those skilled in the art. The various aspects and embodiments disclosed herein are for purposes of illustration and are not intended to be limiting, with the scope and spirit of the disclosure being indicated by the following claims.

1. A method of treading a tire comprising:
providing a tire casing;
providing a material configured to form a tread element on the tire casing, the material being polymerizable;
applying a first layer of the material to the tire casing;
directing a curing source to at least a portion of the first layer, the curing source configured to cure the material on the tire casing;
at least partially curing the at least a portion of the first layer on the tire casing such that the at least a portion of the first layer couples to a surface of the tire casing, forming the tread element; and
removing, by a removal process, uncured material from the tire casing.

2. The method of claim 1, further comprising:
applying a plurality of layers of the material to the first layer, wherein each layer of the plurality of layers is applied sequentially; and
directing the curing source to a first portion of each layer prior to a subsequent layer being applied.

3. The method of claim 2, wherein the removal process includes applying a solvent to the tire casing to dissolve the uncured material such that the uncured material is removed from the tire casing.

4. The method of claim 2, wherein the removal process includes utilizing one of a vacuum, a blower, or an absorbent roller to remove the uncured material from the tire casing.

5. The method of claim 2, wherein the removal process includes applying energy from an energy source to evaporate the uncured material such that the uncured material is removed from the tire casing.

6. The method of claim 1, wherein the first layer of the material is applied using a roller or a sprayer.

7. The method of treading a tire of claim 1, wherein the first layer of the material is applied using film deposition.

8. The method of treading a tire of claim 2, further comprising:
directing the curing source to a second portion of each layer, the second portion separated from the first portion by a distance defining a groove; and
at least partially curing the first portion and the second portion of each layer, leaving uncured material between the first portion and the second portion and forming the groove.

9. A method for forming a tread element, the method comprising:
applying a first layer of uncured material to a surface of a substrate;
directing a curing source to the first layer of uncured material;
curing the first layer of uncured material, forming a first layer of cured material on the substrate; and
sequentially forming a plurality of layers of cured material on the first layer of cured material, each layer of the plurality of layers formed by:
applying a layer of uncured material on an immediately preceding layer of cured material;
directing the curing source to a first groove position on the tread element and a second groove position on the tread element, the first groove position and the second groove position separated by a distance defining a groove; and
curing the layer of uncured material at the first groove position and the second groove position, forming the groove.

10. The method of claim 9, wherein forming each layer of the plurality of layers further comprises removing uncured material between the first groove position and the second groove position.

11. The method of claim 9, wherein the first layer of cured material is partially cured, facilitating bonding with the plurality of layers.

12. The method of claim 9, wherein the uncured material includes at least one of a liquid rubber or liquid polyurethane.

13. The method of claim 9, wherein the uncured material includes a reactive diluent capable of forming an elastomeric material.

14. The method of claim 10, further comprising collecting the removed uncured material.

15. The method of claim 9, wherein forming each layer of the plurality of layers further comprises controlling an exposure of the curing source to the layer of uncured material such that a first portion of the tread element has a first rolling resistance and a second portion of the tread element has a second rolling resistance.

16. The method of claim 9, wherein forming each layer of the plurality of layers further comprises:
directing the curing source to a first sipe position and a second sipe position, the first sipe position and the second sipe position separated by a distance defining a sipe;
curing the layer of uncured material at the first sipe position and the second sipe position; and
removing uncured material between the first sipe position and the second sipe position, forming the sipe.

17. A method of treading a tire comprising:
mounting a tire casing within a rotation machine;
applying a first layer of a material to the tire casing and directing a curing source to at least a portion of the first layer of material as the tire casing is rotated, forming a cured first layer; and
applying a second layer of material over the cured first layer and directing the curing source to at least a portion of the second layer as the tire casing is rotated, forming a cured second layer.

18. The method of claim 17, wherein the rotation machine encloses the tire casing within a chamber having an inert atmosphere.

19. The method of claim 17, further comprising applying a removal process to the tire casing to remove uncured material from a surface of the tire casing.

20. The method of claim 19, wherein the removal process includes applying a solvent to the tire casing by one of spraying the solvent on the tire casing or dipping the tire casing in a tank of the solvent.
